(19) United States
(12) Patent Application Publication
(10) Pub. No.: US 2003/0016639 A1
(43) Pub. Date: Jan. 23, 2003

(54) Telecommunications system and method for delivery of short message service messages to a mobile terminal in data mode

(75) Inventors: Jan Kransmo, Plano, TX (US); Bo Lee, Plano, TX (US)

Correspondence Address: Andre M. Szuwalski, Jenkens & Gilchrist, P.C., 3200 Fountain Place, 1445 Ross Avenue, Dallas, TX, 75202-2799, US

(73) Assignee: Ericsson Inc.

(21) Appl. No.: 09/909,190

(22) Filed: Jul. 19, 2001

(51) Int. Cl. H04B 7/216; H04J 3/24; H04L 12/66

(52) U.S. Cl. 370/335; 370/349; 370/352

(57) ABSTRACT

A telecommunications system and method is disclosed for delivering a Short Message Service (SMS) message to a dual mode mobile terminal in data mode within a network capable of providing both voice services and data services. To receive the SMS message during a data session, the SMS message is encapsulated into an Internet Protocol (IP) packet and routed to the mobile terminal as an electronic mail (e-mail) message. In one embodiment, when the SMS message is received at the Mobile Services Switching Center (MSC) serving the mobile terminal, the MSC determines whether the mobile terminal is in data mode. If so, the MSC converts the SMS message into an email message and routes the e-mail message to the mobile terminal via the Packet Data Service Node (PDSN) serving the mobile terminal. In an alternative embodiment, the MSC routes the SMS message to the Base Station Controller (BSC) serving the mobile terminal. The BSC translates the SMS message into an e-mail message and transmits the e-mail message to the mobile terminal.

### BACKGROUND OF THE PRESENT INVENTION

1. Field of the Invention

The present invention relates generally to telecommunications networks implementing voice and data services, and specifically to the routing of Short Message Service messages to dual mode mobile terminals in data mode.

2. Description of Related Art

A Code Division Multiple Access 2000 (CDMA2000) network supports both data only (DO) mobile terminals, hereinafter referred to as Access Terminals (AT), that utilize only data services and dual mode mobile terminals, hereinafter referred to as Mobile Stations (MS), that utilize both data services and voice services. The CDMA2000 network includes data only carriers for transmitting and receiving data packets and voice only carriers for transmitting and receiving voice. The data carriers are a part of an overlayed packet data network to support packet data speeds above 144 kbps.

Upon initialization, the MS must perform an authentication towards both the data carrier and the voice carrier. However, if no voice services are used, the MS may connect to only the data carrier. If, at a later time, the MS requires voice services, a handoff between the data carrier and the voice carrier is performed.

During the time that a MS is connected to the data carrier, various voice-related services are not available to the MS. For example, the Short Message Service (SMS), which enables users to send and receive short text messages (e.g., maximum of 160 alphanumeric characters), is not currently available to MSs connected to a data carrier. Therefore, if a MS receives an SMS message during a data session on a data carrier, the MS must abandon the data session and connect to a voice carrier within the CDMA2000 network in order to receive the SMS message.

In the current architecture, a voice carrier sends a “QuickPage” message to the MS to indicate that the MS has a page to answer in the voice CDMA2000 network. Thereafter, the MS disconnects the data session, connects to the voice carrier and reconfigures the MS to CDMA2000 voice mode. To receive the SMS message, the MS sends a “Pageresponse” message to the voice carrier.

After reception of the SMS message, the MS must switch back to data mode to complete the data session. To complete such a round trip switch involves extensive processing in the network in order to keep the data mode session alive while the MS is in CDMA2000 voice mode.

### SUMMARY OF THE INVENTION

A system and method is disclosed for delivering a Short Message Service (SMS) message to a MS in data mode within a network providing both voice and data services, such as CDMA2000. During a data session, received SMS messages are encapsulated into Internet Protocol (IP) packets and routed to the MS as an electronic mail (email) message. In one embodiment, when the SMS message is received at the Mobile Services Switching Center (MSC) serving the MS, the MSC determines whether the MS is in data mode. If so, the MSC converts the SMS message into an e-mail message and routes the e-mail message to the MS via the Packet Data Service Node (PDSN) serving the MS.

In an alternative embodiment, the MSC routes the SMS message to the Base Station Controller (BSC) serving the MS. The BSC converts the SMS message into an e-mail message and transmits the e-mail message to the MS via the PDSN. In a further alternative embodiment, the BSC routes the e-mail message directly to the MS without routing the e-mail message through the PDSN.

Advantageously, embodiments of the present invention minimize signaling between the data and voice networks, improve battery life time for the MS, avoid unnecessary packet data session loss and improve customer perception of data services by seamless interworking with voice services.

### BRIEF DESCRIPTION OF THE DRAWINGS

The disclosed invention will be described with reference to the accompanying drawings, which show important sample embodiments of the invention and which are incorporated in the specification hereof by reference, wherein:

FIG. 1 is a block diagram illustrating a CDMA2000 network;

FIG. 2 is a block diagram illustrating one embodiment for the delivery of a Short Message Service (SMS) message to a MS in data mode within a CDMA2000 network;

FIG. 3 is a flow chart illustrating the steps for performing the delivery of the SMS message in accordance with the embodiment shown in FIG. 2 of the drawings;

FIG. 4 is a block diagram illustrating an alternative embodiment for the delivery of the SMS message to the MS in data mode within the CDMA2000 network;

FIG. 5 is a flow chart illustrating the steps for performing the delivery of the SMS message in accordance with the embodiment shown in FIG. 4 of the drawings;

FIG. 6 is a block diagram illustrating a further alternative embodiment for the delivery of the SMS message to the MS in data mode within the CDMA2000 network;

FIG. 7 is a flow chart illustrating the steps for performing the delivery of the SMS message in accordance with the embodiment shown in FIG. 6 of the drawings; and

FIG. 8 is a flow chart illustrating the steps for returning a delivery notification message upon receipt of the SMS message by the MS.

### DETAILED DESCRIPTION OF THE EXEMPLARY EMBODIMENTS

The numerous innovative teachings of the present application will be described with particular reference to the exemplary embodiments. However, it should be understood that this class of embodiments provides only a few examples of the many advantageous uses of the innovative teachings herein. In general, statements made in the specification of the present application do not necessarily delimit any of the various claimed inventions. Moreover, some statements may apply to some inventive features but not to others.

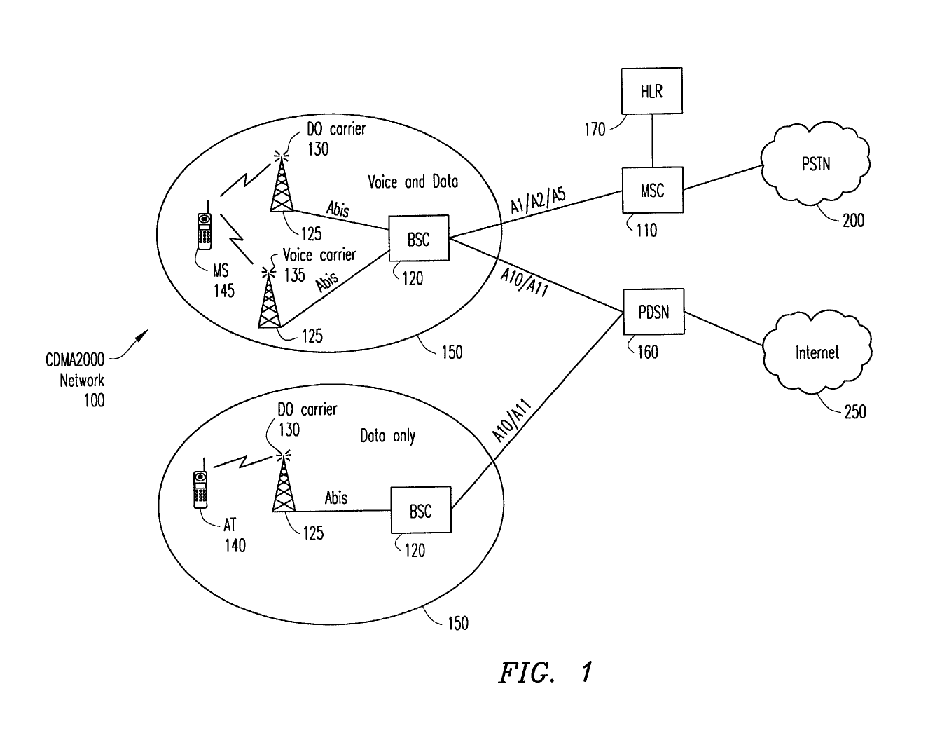

A CDMA2000 network 100 is shown in FIG. 1. In a Code Division Multiple Access (CDMA) system, multiple communications signals, each containing signaling, voice or data information, are transmitted together within a portion of the electromagnetic spectrum. Each communications signal is uniquely encoded at a sending node, and a channel is defined by this unique code. A receiving node decodes the uniquely encoded communications signal to recover the information included in the communications signal.

The sending nodes and receiving nodes include base station controllers (BSC) 120 and AT's 140 and MS's 145. The BSC's 120 encode information on the appropriate down-link channel and transmit the encoded information to the AT's 140 or MS's 145 via one or more base stations 125. The AT's 140 or MS's 145 encode information on the up-link channel associated with the AT 140 or MS 145, and this encoded information is relayed by the base station 125 serving the AT 140 or MS 145 to the associated BSC 120 for decoding.

The CDMA2000 network 100 provides traditional voice services, such as call routing between the Public Switched Telephone Network (PSTN) 200 and the CDMA2000 network 100. An incoming call to a particular MS 145 is routed to the Mobile Services Switching Center (MSC) 110 serving the MS 145 by accessing the Home Location Register (HLR) 170 storing the routing information for the MS 145. The MSC 110, in turn, routes the incoming call to the MS 145 over an A1/A2/A5 interface to the BSC 120 serving the MS 145.

It should be understood that the MSC 110 is responsible for call set-up, routing, control and termination of a call. The MSC 110 is also responsible for handling handovers between two BSC's 120 and for handling supplementary subscriber services. The BSC 120 is responsible for operation, maintenance and administration of the base stations 125, speech coding, rate adaptation and handling of the radio resources. The base stations 125 provide the RF interface (referred to herein as a carrier 130 or 135) between the AT's 140 or MS's 145 and the network 100 via one or more transceivers. Each carrier 130 or 135 serves one cell or sector. It should further be understood that the BSC 120 may be a separate node or may be co-located with one or more base stations 125.

In addition to voice services, a CDMA2000 network 100 provides packet data services with high data rates (e.g., up to 2 Mbps per user) and high throughput. A data only (DO) mobile terminal (referred to herein as an Access Terminal (AT)) 140 can connect to a DO carrier 130 to engage in a data session. During the data session, data packets are transmitted between the AT 140 and the Internet 250 via the DO carrier 130, BSC 120 and a Packet Data Service Node (PDSN) 160. The PDSN 160 is responsible for routing all data packets between the AT 140 and the Internet 250, and connects to one or more BSC's 120 via an A10/A11 interface. Information received at a BSC 120 for a particular AT 140 is uniquely encoded and transmitted via an Abis interface to the DO carrier 130 serving the AT 140.

CDMA2000 networks 100 also provide interworking between data mode and voice mode for dual mode mobile terminals (referred to herein as a Mobile Station (MS)) 145. Therefore, to switch between data mode and voice mode, a MS 145 need only perform a handoff from a DO carrier 130 to a voice carrier 135 within the BSC area 150. While involved in a data session with a DO carrier 130, the MS 145 is further capable of monitoring the voice carrier 135 for incoming pages to the MS 145 informing the MS 145 of incoming voice services (e.g., an incoming voice call or an incoming Short Message Service (SMS) message).

In the traditional CDMA2000 architecture, if a MS 145 receives an SMS message during a data session, the MS 145 must abandon the data session and connect to a voice carrier 135 within the BSC area 120 in order to receive the SMS message. In accordance with embodiments of the present invention, instead of sending a page to the MS 145 and forcing the MS 145 to abandon the data session, the SMS message can be encapsulated into an Internet Protocol (IP) packet and routed to the MS 145 as an electronic mail (e-mail) message without interrupting the data session.

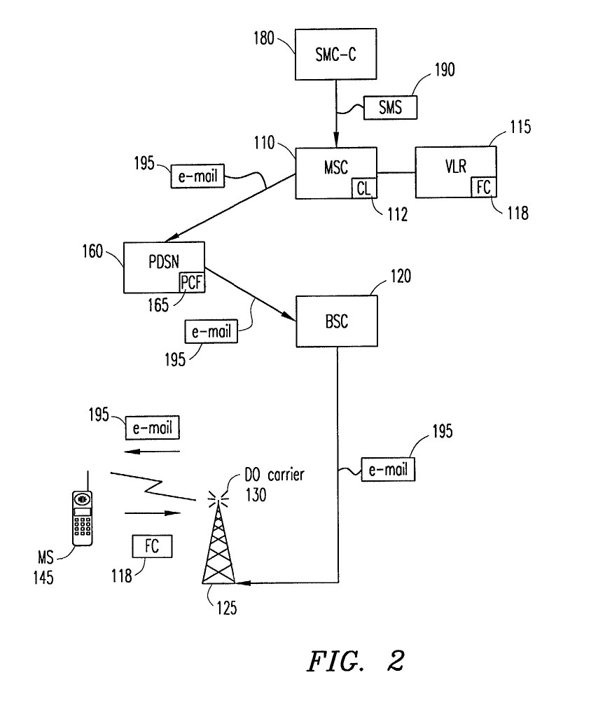

In one embodiment, as shown in FIG. 2, when the MS 145 connects to the DO carrier 130 for a data session, the MS 145 sends a feature code 118 to the MSC 110 indicating that the MS 145 is currently in DO mode. The MSC 110 stores this feature code 118 within a subscriber record associated with the MS 145 within a Visitor Location Register (VLR) 115 associated with the MSC 110. It should be understood that the VLR 115 may be a stand-alone node or co-located with the MSC 110. It should further be understood that the feature code 118 is merely one example of how the MSC 110 has knowledge of whether the MS 145 is currently involved in a data session. There may be many other ways in which the MSC 110 is informed that the MS 145 is currently in data mode.

All SMS messages 190 are routed through a Short Message Service Center (SMS-C) 180, which acts as a store-and-forward center for text messages. The SMS-C 180 routes the SMS message 190 to the appropriate MSC 110 for delivery of the SMS message 190 to the MS 145. When an MSC 110 receives an SMS message 190 for a MS 145, the MSC 110 checks the MS's 145 subscriber record in the VLR 115 for the DO feature code 118 to determine if the MS 145 is currently in DO mode.

If the MS 145 is in DO mode (as indicated by feature code 118), conversion logic 112 within the MSC 110 converts the SMS message 190 into an e-mail message 195 by stripping the SMS headers off of the SMS message 190, encapsulating the text into an IP packet and routing the IP packet to the MS 145 using the IP address of the MS 145. Typically, the IP address has the form of the Simple Mail Transfer Protocol (SMTP) or Internet mail (email) address of the MS 145. For example, the e-mail address may be the International Mobility Subscriber Identity (IMSI) of the MS 145 at the Internet Service Provider (ISP) of the MS 145 (i.e., IMSI@ISP.com). It should be understood that the IMSI is the unique subscriber number of the MS 145, and is not the dialable number associated with the MS 145. The IMSI is used for signaling purposes within the CDMA2000 network 100 and consists of a Mobile Country Code (MCC), Mobile Network Code (MNC) and Mobile Subscriber Identification Number (MSIN). The IMSI has a maximum length of 15 digits.

The IP packet is routed to the MS 145 using the Transmission Control Protocol (TCP)/Internet Protocol (IP) via the PDSN 160, BSC 120 and DO carrier 130 serving the MS 145. For data services, the PDSN 160 (instead of the MSC/VLR 110/115) stores the sector ID (or cell ID) of the MS 145. It should be understood that the sector ID identifies the particular DO carrier 130 to route the email message 195 to and the sector that the DO carrier 130 should broadcast the e-mail message 195 in. The sector ID is maintained in a Packet Control Function (PCF) 165 within the PDSN 160. Therefore, when the MSC 110 receives the SMS message 190, the MSC 110 does not have knowledge of the sector ID for routing of the e-mail message 195. Thus, the MSC 110 must send the e-mail message to the PDSN 160 to obtain the sector ID for the MS 145.

The MS 145 receives the IP packet as an e-mail message 195 in the inbox of the MS 145. The e-mail message 195 can be received as part of a packet data stream or may be received as part of a new type of e-mail stream. Since the SMS message 190 is received as an email message 195, the MS 145 does not have to leave the ongoing data session to be able to receive the text of the SMS message 190. Advantageously, receiving the SMS message 190 during an ongoing data session minimizes signaling to both the voice and data networks, saves battery life time for the MS 145, avoids unnecessary packet data session loss and improves customer perception of data services by seamless interworking.

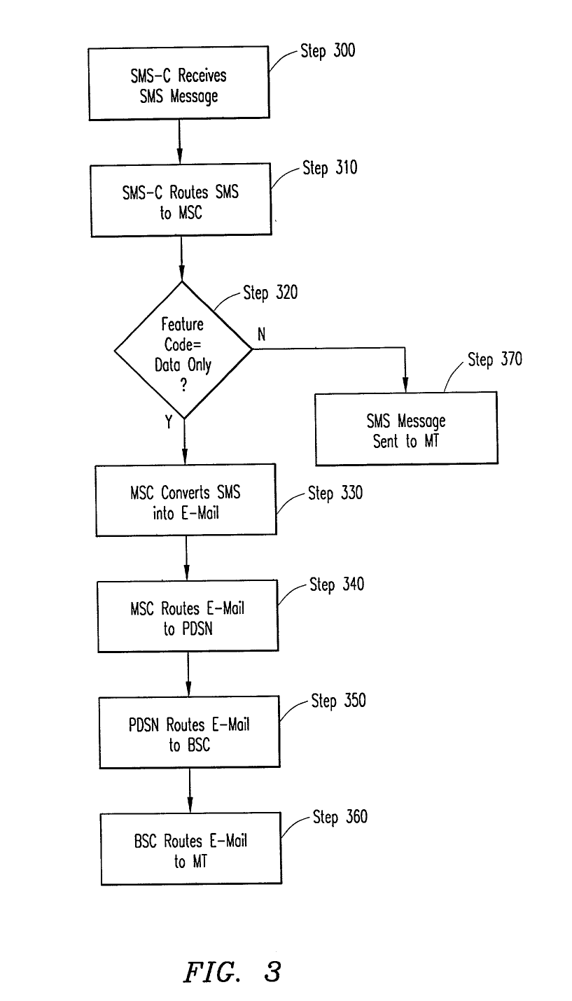

Reference is now made to FIG. 3 where the steps for routing the SMS message in accordance with the embodiment of FIG. 2 are shown. When the SMS-C receives an SMS message for a MS within a CDMA2000 network (step 300), the SMS-C routes the SMS message to the MSC serving the MS (step 310). If the DO feature code is present in the subscriber record of the MS (step 320), the MSC converts the SMS message into an e-mail message (step 330), as described above. Thereafter, the MSC routes the e-mail message to the PDSN (step 340), which in turn, routes the e-mail message to the BSC (step 350) for delivery of the e-mail message to the MS (step 360). However, if the DO feature code is not present in the subscriber record of the MS (step 320), the MSC routes the SMS message to the MS (step 370), as conventionally done (i.e., SMS message is routed to the BSC, which forwards the SMS message to the voice carrier for transmission of the SMS message to the MS via the air interface).

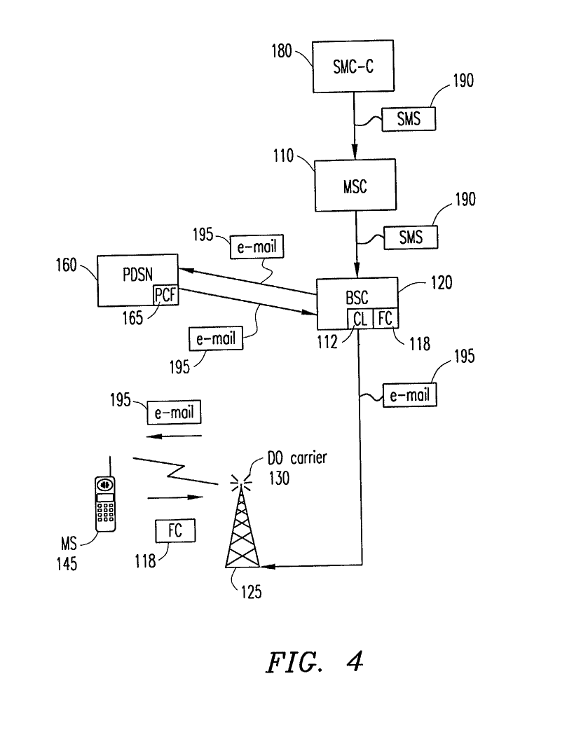

In another embodiment, as shown in FIG. 4, the BSC 120 converts the SMS message 190 into an e-mail message 195. In order for the BSC 120 to perform the conversion, the BSC 120 must store the DO feature code 118 transmitted by the MS 145 when the MS 145 begins the data session. Thus, when the SMS message 190 arrives at the BSC 120, the BSC checks whether the MS 145 is currently involved in a data session, and if so, conversion logic 112 within the BSC 120 converts the SMS message 190 into an e-mail message 195. To deliver the e-mail message 195 to the MS 145, the BSC 120 sends the e-mail message 195 to the PDSN 160, which routes the e-mail message to the MS 145 via the BSC 120 and the DO carrier 130, as discussed above.

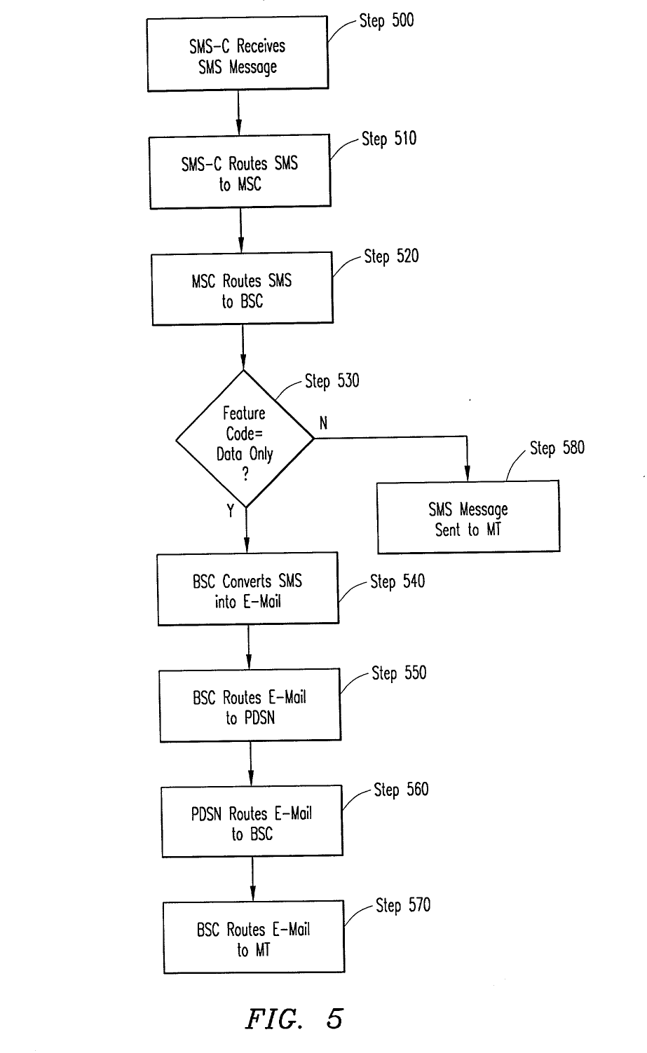

Reference is now made to FIG. 5, which lists the steps for sending the SMS message to the MS in accordance with the embodiment shown in FIG. 4. When the SMS-C receives the SMS message (step 500), the SMS-C routes the SMS message to the MSC (step 510). The MSC determines the BSC serving the MS, and routes the SMS message to that BSC (step 520). Since the BSC stores the DO feature code sent by the MS upon beginning a data session, the BSC makes the determination as to whether the MS is currently involved in a data session (step 530).

If so, the BSC converts the SMS message into an email message (step 540), and sends the e-mail message to the PDSN (step 550). Thereafter, the PDSN routes the email message back to the BSC with appropriate routing information for the MS (step 560). The BSC, in turn, delivers the SMS message to the MS via the DO carrier (step 570). If the BSC has not received the DO feature code from the MS (step 530), the BSC routes the SMS message to the MS, as conventionally done (step 580).

In the embodiment of FIGS. 4 and 5, the BSC sends the e-mail message to the PDSN for delivery of the e-mail message to the MT. As discussed above, for data services, the PDSN (instead of the MSC/VLR) stores the sector ID (or cell ID) of the MS within a Packet Control Function (PCF) of the PDSN. Therefore, in FIGS. 4 and 5, when the BSC receives the SMS message, the BSC must send the e-mail message to the PDSN to obtain the sector ID for the MS.

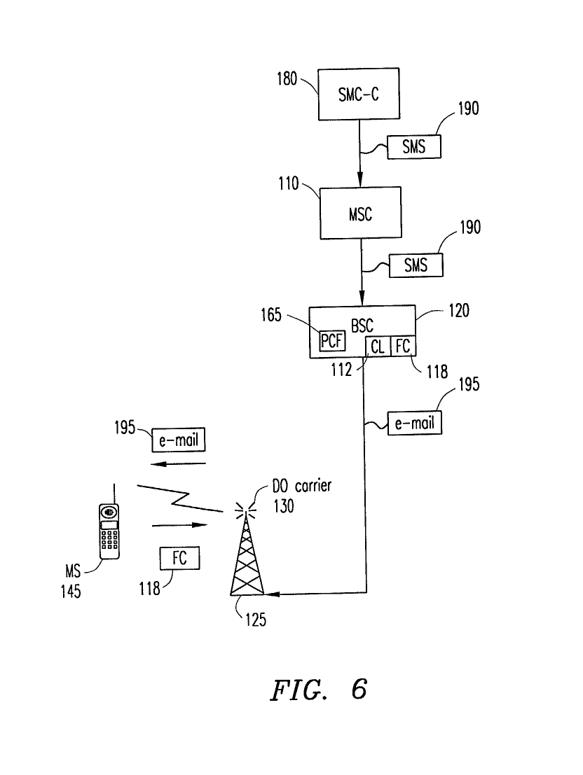

In a further alternative embodiment, as shown in FIG. 6, the PCF 165 can be included within the BSC 120, instead of the PDSN 160 (shown in FIG. 4). Therefore, when the BSC 120 receives the SMS message 190 and determines that the MS 145 is involved in a data session (e.g., by checking the DO feature code 118), the BSC 120 can convert the SMS message 190 into an e-mail message 195, using conversion logic 112, and route the e-mail message 195 directly to the MS 145 via the DO carrier 130 using the PCF 165.

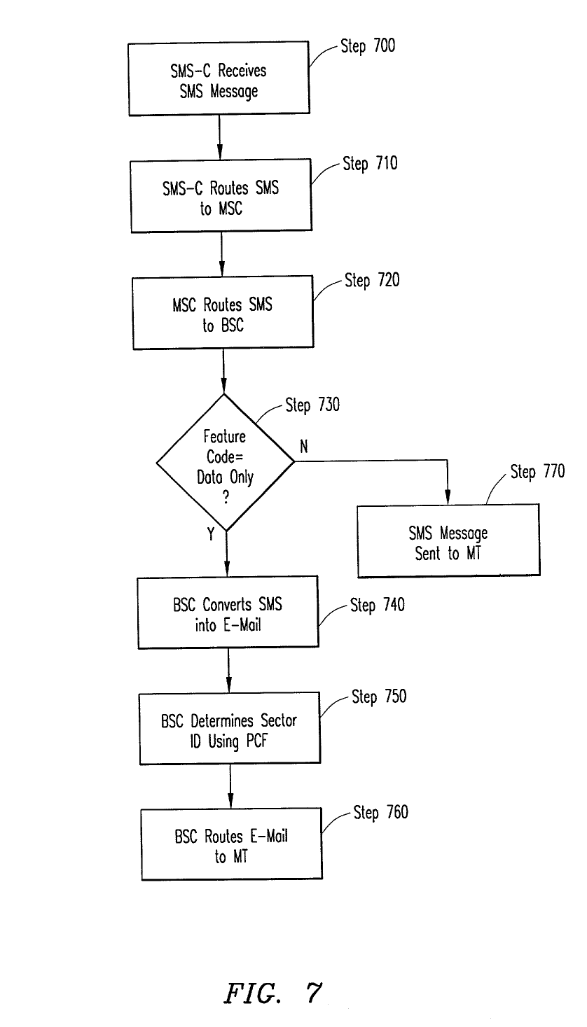

Reference is now made to FIG. 7 of the drawings, which lists the steps for delivering the e-mail message to the MS in accordance with the embodiment shown in FIG. 6. When the SMS-C receives the SMS message for the MS (step 700), the SMS-C routes the SMS message to the MSC (step 710). The MSC determines the serving BSC and routes the SMS message to that BSC (step 720). When the BSC receives the SMS message, the BSC determines whether the MS previously sent the DO feature code (step 730), and if so, converts the SMS message into the e-mail message (step 740).

To route the e-mail message to the MS, the BSC accesses the PCF within the BSC to determine routing information for the MS (e.g., the sector ID of the sector that the MS is currently located in) (step 750). Using this sector ID, the BSC routes the e-mail message to the appropriate DO carrier, which encodes the e-mail message and broadcasts the e-mail message to the MS in the sector that the MS is located in (step 760).

The Short Message Service permits an SMS originator to request notification regarding whether the delivery of a particular SMS message was successful or unsuccessful. In order to implement this functionality within the CDMA2000 network, the MS must be able to respond to the SMS-C upon successful reception of an SMS message.

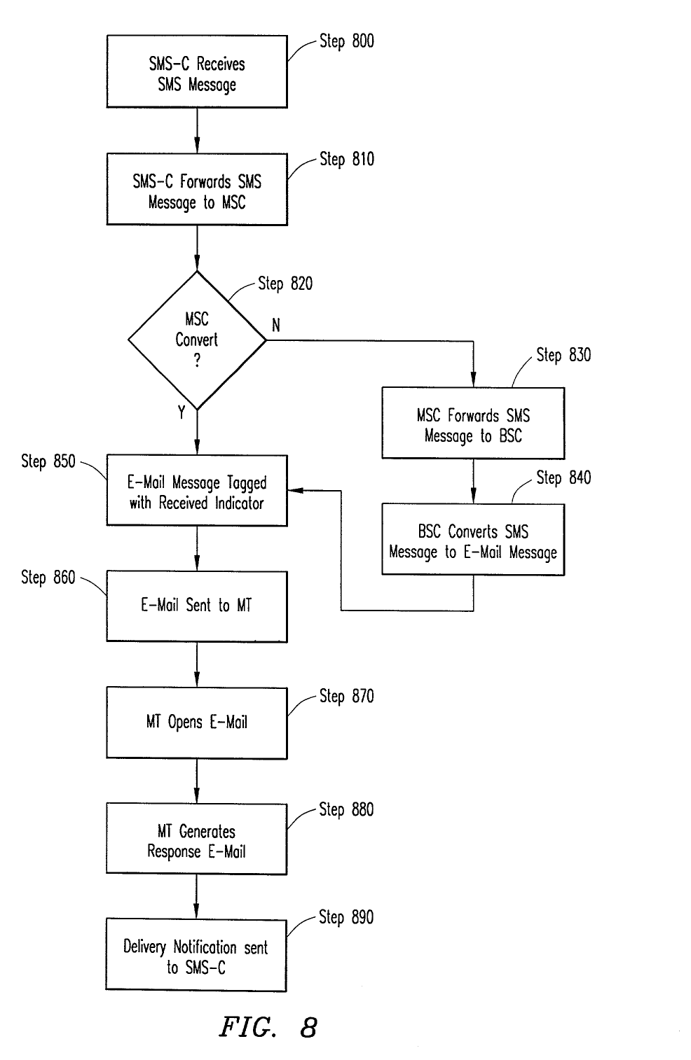

Referring now to the steps listed in FIG. 8, as described above in connection with FIGS. 2-7, when the SMS-C receives an SMS message for a MS in DO mode (step 800), the SMS-C forwards the SMS message to the MSC (step 810), which either converts the SMS message to an e-mail message (step 820) or forwards the SMS message to the BSC (step 830) to perform the conversion (step 840). In either case, when the SMS message is converted into the e-mail message, the MSC or the BSC must tag the e-mail message with a received indicator (step 850) before the e-mail message is sent to the MS (step 860).

Once the e-mail is opened (step 870), the received indicator automatically generates and sends a response email to the originator indicating that the e-mail has been read (step 880). Therefore, when the MSC or BSC sends the e-mail message to the MS, and the MS opens the e-mail message, the received indicator causes the MS to generate and transmit a response e-mail message to the MSC or BSC, respectively. Upon receiving the response message, the MSC or BSC transmits a delivery notification message to the SMS-C indicating that the SMS message has been successfully delivered (step 890).

It should be noted that the exemplary embodiments described herein may be applied to any network capable of providing both voice services and data services. The CDMA2000 network is used above merely as an example of such a network.

As will be recognized by those skilled in the art, the innovative concepts described in the present application can be modified and varied over a wide range of applications. Accordingly, the scope of patented subject matter should not be limited to any of the specific exemplary teachings discussed, but is instead defined by the following claims.

What is claimed is:

1. A telecommunications system for delivering a Short Message Service (SMS) message within a network capable of providing both voice services on a voice carrier and data services on a data only carrier, said telecommunications system comprising:
a mobile station (MS) supporting both voice services and data services, said MS being currently involved in a data session on said data only carrier; and
a node in wireless communication with said MS for receiving said SMS message, encapsulating said SMS message into an Internet Protocol (IP) packet and routing said SMS message to said MS as an electronic mail message over said data only carrier without disrupting said data session.

2. The telecommunications system of claim 1, wherein said node further operates to check whether said MS is involved in said data session prior to encapsulating said SMS message into said IP packet, said node transmitting said SMS message to said MS when said MS is not involved in said data session.

3. The telecommunications system of claim 2, wherein said MS transmits to said node a feature code indicating that said MS is in data mode when said data session begins, said node encapsulating said SMS message into said IP packet only when said node has received said feature code.

4. The telecommunications system of claim 3, wherein said node is a Mobile Services Switching Center.

5. The telecommunications system of claim 4, wherein said feature code is stored within a Visitor Location Register associated with said Mobile Services Switching Center.

6. The telecommunications system of claim 4, further comprising:
a Packet Data Service Node in wireless communication with said MS for said data session, said Mobile Services Switching Center routing said electronic message to said Packet Data Service Node for delivery of said electronic mail message to said MS.

7. The telecommunications system of claim 3, wherein said node is a Base Station Controller.

8. The telecommunications system of claim 7, further comprising:
a Packet Data Service Node in wireless communication with said MS for said data session, said Base Station Controller routing said electronic message to said Packet Data Service Node for delivery of said electronic mail message to said MS.

9. The telecommunications system of claim 7, wherein said Base Station Controller has a Packet Control Function therein for determining routing information associated with said MS for said data session, said Base Station Controller delivering said electronic mail message to said MS using said routing information.

10. The telecommunications system of claim 1, further comprising:
a Short Message Service Center for routing said SMS message to said node.

11. The telecommunications system of claim 10, wherein said node tags said electronic mail message with a received indicator, said received indicator generating a response message to said node when said MS opens said electronic mail message, said node transmitting a delivery notification message to said Short Message Service Center upon receipt of said response message.

12. The telecommunications system of claim 1, wherein said electronic mail message is routed to said MS using an electronic mail address for said MS.

13. The telecommunications system of claim 12, wherein said electronic mail address includes an International Mobile Subscriber Identity number of said MS at an Internet Service Provider of said MS.

14. The telecommunications system of claim 1, wherein said network is a Code Division Multiple Access 2000 network.

15. A Mobile Services Switching Center for delivering a Short Message Service (SMS) message to a mobile station (MS) supporting both voice services and data services, said Mobile Services Switching Center comprising:
means for determining whether said MS is currently involved in a data session on a data only carrier; and
conversion logic for encapsulating said SMS message into an Internet Protocol (IP) packet and routing said SMS message to said MS over said data only carrier as an electronic mail message when said MS is involved in said data session.

16. The Mobile Services Switching Center of claim 15, wherein said means for determining comprises a feature code indicating that said MS is involved in said data session, said feature code being sent by said MS at the start of said data session.

17. The Mobile Services Switching Center of claim 16, wherein said feature code is stored in a Visitor Location Register associated with said Mobile Services Switching Center.

18. The Mobile Services Switching Center of claim 15, further comprising:
means for receiving said SMS message from a Short Message Service Center.

19. The Mobile Services Switching Center of claim 18, wherein said conversion logic tags said electronic mail message with a received indicator, said received indicator generating a response message to said Mobile Services Switching Center when said MS opens said electronic mail message.

20. The Mobile Services Switching Center of claim 19, further comprising:
means for transmitting a delivery notification message to said Short Message Service Center upon receipt of said response message.

21. The Mobile Services Switching Center of claim 15, wherein said conversion logic routes said electronic mail message to said MS using an electronic mail address for said MS.

22. The Mobile Services Switching Center of claim 21, wherein said electronic mail address includes an International Mobile Subscriber Identity number of said MS at an Internet Service Provider of said MS.

23. A Base Station Controller for delivering a Short Message Service (SMS) message to a mobile station (MS) supporting both voice services and data services, said Base Station Controller comprising:
means for determining whether said MS is currently involved in a data session on a data only carrier; and
conversion logic for encapsulating said SMS message into an Internet Protocol (IP) packet and routing said SMS message to said MS over said data only carrier as an electronic mail message when said MS is involved in said data session.

24. The Base Station Controller of claim 23, wherein said means for determining comprises a feature code indicating that said MS is involved in said data session, said feature code being sent by said MS at the start of said data session.

25. The Base Station Controller of claim 23, further comprising:
a Packet Control Function for determining routing information associated with said MS for said data session, said electronic mail message being delivered to said MS using said routing information.

26. The Base Station Controller of claim 23, further comprising:
means for receiving said SMS message from a Short Message Service Center.

27. The Base Station Controller of claim 26, wherein said conversion logic tags said electronic mail message with a received indicator, said received indicator generating a response message to said Base Station Controller when said MS opens said electronic mail message.

28. The Base Station Controller of claim 27, further comprising:
means for transmitting a delivery notification message to said Short Message Service Center upon receipt of said response message.

29. The Base Station Controller of claim 23, wherein said conversion logic routes said electronic mail message to said MS using an electronic mail address for said MS.

30. The Base Station Controller of claim 29, wherein said electronic mail address includes an International Mobile Subscriber Identity number of said MS at an Internet Service Provider of said MS.

31. A method for delivering a Short Message Service (SMS) message within a network capable of providing both voice services on a voice carrier and data services on a data only carrier, said method comprising:
receiving at a node in wireless communication with a mobile station (MS) supporting both voice services and data services said SMS message;
determining whether said MS is currently involved in a data session on said data only carrier;
if not, routing said SMS message to said MS via said voice carrier; and
if so:
encapsulating said SMS message into an Internet Protocol (IP) packet, and
routing said SMS message to said MS as an electronic mail message without disrupting said data session.

32. The method of claim 31, wherein said step of determining further comprises:
transmitting a feature code indicating that said MS is in data mode when said data session begins from said MS to said node.

33. The method of claim 32, wherein said node is a Mobile Services Switching Center and further comprising:
storing said feature code within a Visitor Location Register associated with said Mobile Services Switching Center.

34. The method of claim 33, wherein said step of routing further comprises:
routing said electronic message from said Mobile Services Switching Center to a Packet Data Service Node in wireless communication with said MS for said data session; and
delivering said electronic mail message from said Packet Data Service Node to said MS.

35. The method of claim 31, wherein said node is a Base Station Controller, and wherein said step of routing further comprises:
routing said electronic message from said Base Station Controller to a Packet Data Service Node in wireless communication with said MS for said data session; and
delivering said electronic mail message from said Packet Data Service Node to said MS.

36. The method of claim 31, wherein said node is a Base Station Controller, and wherein said step of routing further comprises:
determining, by said Base Station Controller, routing information associated with said MS for said data session; and
delivering said electronic mail message from said Base Station Controller to said MS using said routing information.

37. The method of claim 31, wherein said step of receiving further comprises:
receiving said SMS message from a Short Message Service Center.

38. The method of claim 37, further comprising:
tagging said electronic mail message with a received indicator;
generating, by said received indicator, a response message to said node when said MS opens said electronic mail message; and
transmitting a delivery notification message from said node to said Short Message Service Center upon receipt of said response message.

39. The method of claim 31, wherein said step of routing further comprises:
routing said electronic mail message to said MS using an electronic mail address for said MS.
